(19) United States
(12) Patent Application Publication
(10) Pub. No.: US 2026/0331955 A1
(43) Pub. Date: Oct. 22, 2026

(54) PORTABLE CHARGING DEVICE THAT PREVENTS PHONES AND MOUNTS FROM FALLING

(71) Applicant: OXTI Pte Ltd, Singapore (SG)

(72) Inventor: Yu-Lin LIN, Singapore (SG)

(21) Appl. No.: 19/185,292

(22) Filed: Apr. 22, 2025

(51) Int. Cl. H02J 50/10; H01M 50/233; H01M 50/244; H01M 50/247; H01M 50/264; H02J 50/90

(52) U.S. Cl. CPC H02J 50/10; H01M 50/233; H01M 50/244; H01M 50/247; H01M 50/264; H02J 50/90

(57) ABSTRACT

The portable charging device includes a main member and a support stand. The main member includes a housing and a battery positioned inside the housing. The housing is equipped with a first magnetic surface and a second magnetic surface. The support stand is located on one side of the main member and equipped with a third magnetic surface. When the main member is attached to the support stand, the second magnetic surface magnetically and securely adheres to the third magnetic surface. The first magnetic surface and second magnetic surface of the main member are used to magnetically attach and secure the mobile communication device and the support stand, respectively, preventing the mobile communication device from falling off the support stand if accidentally bumped.

### BACKGROUND OF THE INVENTION

### (A) TECHNICAL FIELD OF THE INVENTION

The present invention generally relates to portable charging devices, and more particular to a portable charging device capable of securing the attachment of a mobile communication device during charging.

### (B) DESCRIPTION OF THE PRIOR ART

A portable charging device (also known as a power bank) is a type of portable battery designed to provide on-the-go charging services for mobile communication devices such as smartphones, tablets, and laptops.

For example, the Republic of China, Taiwan, Patent No. M461242 describes a "portable power device" that includes a control circuit board located inside the power bank, and a first power output port, second power output port, light-emitting module, and power input port located on the device and electrically connected to the control circuit board. The control circuit board is further equipped with at least one battery module, and the output current of the first power output port is greater than that of the second power output port.

However, when conventional portable charging devices are used with mobile communication devices (such as smartphones), there is a risk that accidental contact with the mobile communication device while it is being charged may cause the device to fall and become damaged.

### SUMMARY OF THE INVENTION

Therefore, the present invention discloses a portable charging device capable of securing the attachment of a mobile communication device during charging. The portable charging device includes a main member and a support stand. The main member includes a housing and a battery positioned inside the housing. The housing is equipped with a first magnetic surface and a second magnetic surface. The support stand is located on one side of the main member and equipped with a third magnetic surface. When the main member is attached to the support stand, the second magnetic surface magnetically and securely adheres to the third magnetic surface.

Additionally, a mobile communication device can be attached to one side of the main member. The mobile communication device is equipped with a fourth magnetic surface. When the mobile communication device is attached to the main member, the first magnetic surface and the fourth magnetic surface magnetically attract and secure to each other.

Specifically, the battery is a solid-state battery.

Specifically, the first magnetic surface, second magnetic surface, and third magnetic surface are double-sided magnets.

The portable charging device can be applied to a mobile communication device equipped with a fourth magnetic surface. When the mobile communication device is attached to the portable charging device, the first magnetic surface and the fourth magnetic surface magnetically attract and secure to each other. In this way, the first magnetic surface and second magnetic surface of the portable charging device respectively attach and secure the mobile communication device and the support stand, helping to prevent the mobile communication device from falling off the support stand if accidentally bumped.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a profile diagram showing an application scenario of the portable charging device according to an embodiment of the present invention.

FIG. 2 is a perspective diagram showing a portable charging device according to an embodiment of the present invention.

FIG. 3 is a perspective break-down diagram showing the portable charging device of FIG. 2.

FIG. 4 is a perspective diagram showing an application scenario of the portable charging device of FIG. 2.

FIG. 5 is a perspective diagram showing another application scenario of the portable charging device of FIG. 2.

FIG. 6 is a schematic profile diagram showing the portable charging device of FIG. 2 under wireless charging.

FIG. 7 is a schematic perspective diagram showing the portable charging device of FIG. 2 under wireless charging.

FIG. 8 is a schematic profile diagram showing the portable charging device of FIG. 2 under wired charging.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

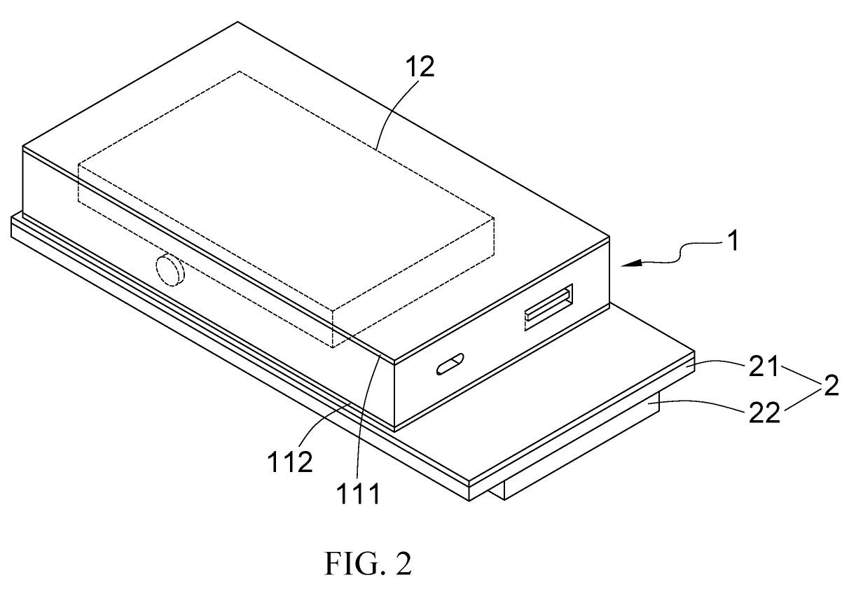

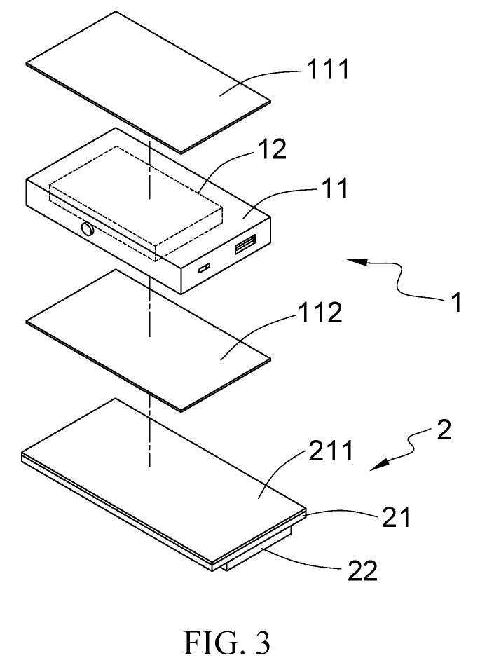

As shown in FIGS. 2 and 3, a portable charging device according to an embodiment of the present invention includes the following components.

A main member 1 includes a housing 11 and a battery 12. The battery 12 is positioned inside the housing 11, which features a first magnetic surface 111 and a second magnetic surface 112. The battery 12 may be a solid-state battery—an advanced battery technology that replaces the liquid electrolyte found in conventional batteries with a solid electrolyte. Unlike traditional lithium-ion batteries, solid-state batteries use solid materials such as ceramics, polymers, or other solid chemical substances to conduct electricity.

A support stand 2 is located on one side of the main member 1 and includes a third magnetic surface 211. When the main member 1 is attached to the support stand 2, the second magnetic surface 112 magnetically adheres to the third magnetic surface 211, securing the connection. The support stand 2 may include a body 21 and a support leg 22. The body 21 holds the main member 1, while the support leg 22 supports the body 21 to maintain its stability.

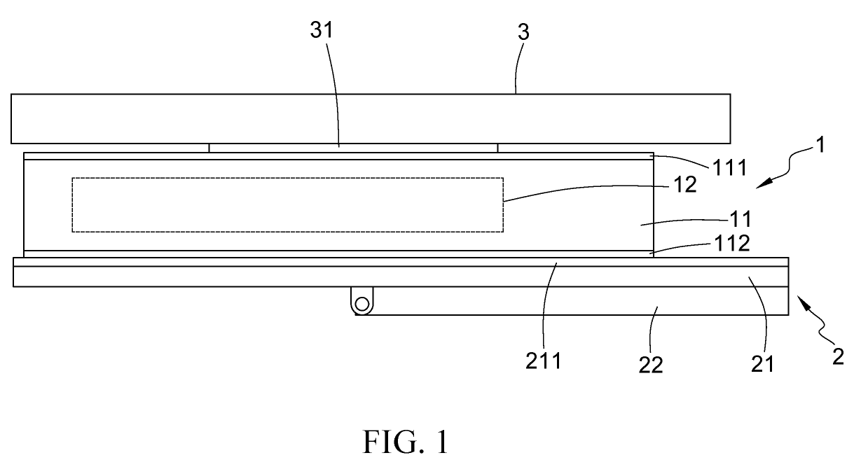

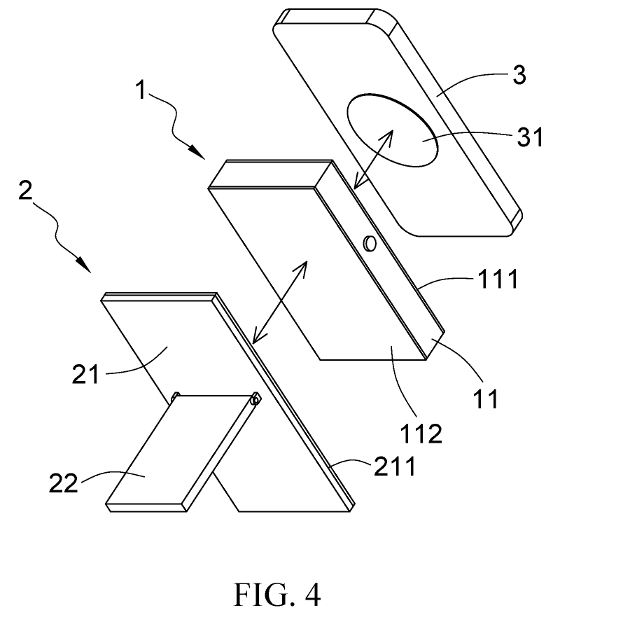

As shown in FIGS. 1 and 4, a mobile communication device 3 is attached to one side of the main member 1. The mobile communication device 3 includes a fourth magnetic surface 31. When the mobile communication device 3 is attached to the main member 1, the first magnetic surface 111 and the fourth magnetic surface 31 magnetically attract and secure to each other. The first magnetic surface 111, second magnetic surface 112, and third magnetic surface 211 may all be double-sided magnets. The fourth magnetic surface 31 may also be a double-sided magnet. A double-sided magnet is a type of magnet that exhibits magnetic properties on both sides. Unlike traditional single-sided magnets, double-sided magnets are magnetic on both surfaces and can be used to attract or repel ferromagnetic materials.

The mobile communication device 3 refers to an electronic device capable of wireless communication, typically with mobility, supporting voice calls, data transmission, and other communication functions. Examples of such devices include smartphones and tablets.

In practical use, the battery 12 inside the main member 1 stores electrical energy when the main member 1 is connected to an external power source. Electrical energy from the external source is then delivered to the main member 1 and stored in the battery 12. Once the battery 12 is fully charged or has sufficient energy, the main member 1 enters standby mode, ready to supply power to the mobile communication device 3. The main member 1 can be connected to the mobile communication device 3 via a charging cable. Based on power demand, the main member 1 begins transferring energy to the mobile communication device 3. Upon receiving power from the main member 1, the mobile communication device 3 routes the energy to its internal charging circuit, where it is stored in the device’s internal battery. The mobile communication device 3 monitors the status of its internal battery to ensure the charging process proceeds smoothly. Once the internal battery is fully charged, the device stops charging to prevent overcharging.

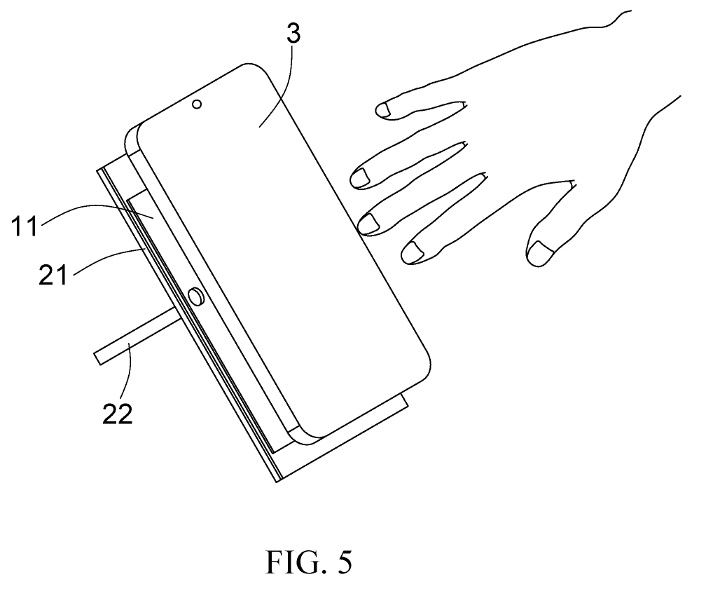

As shown in FIGS. 1, 4, and 5, the first magnetic surface 111 and second magnetic surface 112 of the main member 1 are used to magnetically attach and secure the mobile communication device 3 and the support stand 2, respectively, preventing the mobile communication device 3 from falling off the support stand 2 if accidentally bumped.

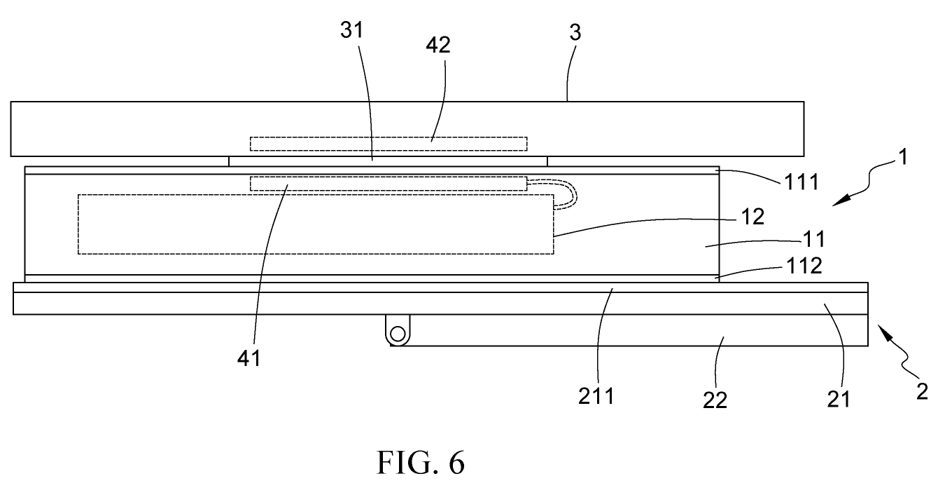

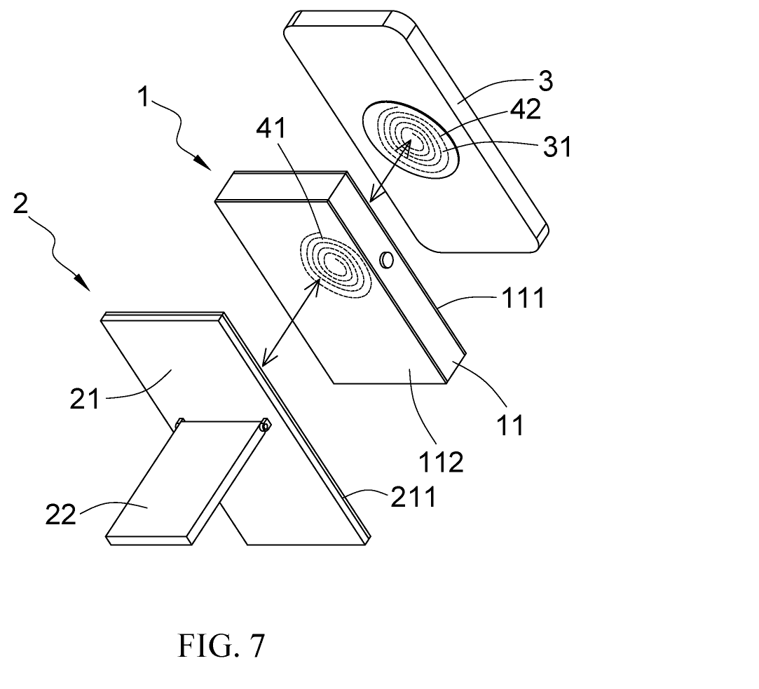

Please refer to FIGS. 6, 7, and 8. The portable charging device of the present invention can be configured for either wireless or wired charging based on user preference. In FIGS. 6 and 7, the wireless charging requires a transmitting coil 41 installed in the main member 1 and a receiving coil 42 installed in the mobile communication device 3. When the main member is activated 1, the battery 12 supplies power by driving current flow with its terminal voltage. The current passes through the transmitting coil 41, generating a magnetic field around it according to Ampere’s Law. As the current varies, the magnetic field also changes, creating an alternating magnetic field. When the mobile communication device 3 is placed near the main member 1, the receiving coil 42 detects the alternating magnetic field generated by the transmitting coil 41. According to Faraday’s Law of electromagnetic induction, the receiving coil 42 converts the alternating magnetic field into alternating current (AC). Since the generated power is in AC, the mobile communication device 3 uses an internal rectifier circuit to convert the AC into direct current (DC), as the internal components of the mobile communication device 3 often requires DC electricity.

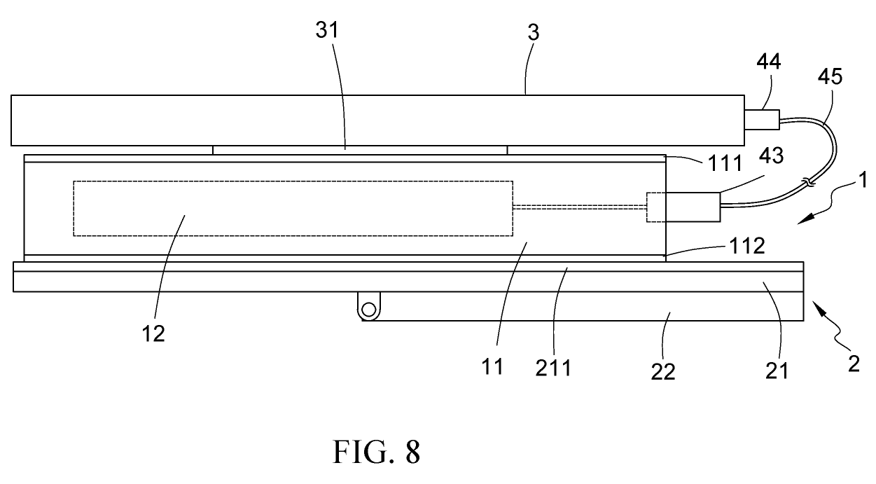

As shown in FIG. 8, the wired charging process requires the installation of a first connection port 43 on the main member 1 and a second connection port 44 on the mobile communication device 3, with a connection cable 45 linking the two ports. When the main member 1 and the mobile communication device 3 are connected via the connection cable 45, the main member 1 activates the battery 12, which supplies power by driving current flow through its terminal voltage. The current flows from the main member 1’s first connection port 43, through the connection cable 45, to the mobile communication device 3’s second connection port 44. The connection cable 45 is responsible for transferring current from the main member 1 to the mobile communication device 3. Once the current enters the mobile communication device 3’s second connection port 44, the device’s Battery Management System (BMS) directs the current to its internal battery, which stores the energy received from the main member 1. When the internal battery of the mobile communication device 3 becomes fully charged, the BMS automatically stops the wired charging process.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A portable charging device, comprising:
a main member comprising a housing and a battery positioned inside the housing, where the housing is equipped with a first magnetic surface and a second magnetic surface; and
a support stand located on one side of the main member and equipped with a third magnetic surface, where, when the main member is attached to the support stand, the second magnetic surface magnetically and securely adheres to the third magnetic surface.

2. The portable charging device according to claim 1, wherein a mobile communication device is attached to one side of the main member; the mobile communication device is equipped with a fourth magnetic surface; and, when the mobile communication device is attached to the main member, the first magnetic surface and the fourth magnetic surface magnetically attract and secure to each other.

3. The portable charging device according to claim 1, wherein the battery is a solid-state battery.

4. The portable charging device according to claim 1, wherein the first magnetic surface, second magnetic surface, and third magnetic surface are double-sided magnets.
